(19) United States
(12) Patent Application Publication
(10) Pub. No.: US 2022/0068040 A1
(43) Pub. Date: Mar. 3, 2022

(54) INFORMATION PROVIDING SYSTEM, INFORMATION PROVIDING DEVICE, AND COMPUTER READABLE RECORDING MEDIUM

(71) Applicant: TOYOTA JIDOSHA KABUSHIKI KAISHA, Toyota-shi (JP)

(72) Inventor: Hiroshi MAJIMA, Shinagawa-ku (JP)

(73) Assignee: TOYOTA JIDOSHA KABUSHIKI KAISHA, Toyota-shi (JP)

(21) Appl. No.: 17/386,004

(22) Filed: Jul. 27, 2021

(30) Foreign Application Priority Data
Aug. 27, 2020 (JP) 2020-143638

(51) Int. Cl. G07B 15/02; G06Q 10/06; G06Q 50/30; G06Q 30/02; G01S 19/42

(52) U.S. Cl. CPC G07B 15/02; G06Q 10/06315; G06Q 50/30; G06Q 2240/00; G06Q 30/0284; G01S 19/42; G06Q 30/0201

(57) ABSTRACT

An information providing system includes: a server including a first processor configured to provide an excursion pass that allows a user to use a plurality of transportation units to a terminal of the user, estimate a transportation unit used by the user among the plurality of transportation units, and a usage section of the transportation unit, calculate allocation of sales of the excursion pass to each operator providing the plurality of transportation units based on an estimation result of the transportation unit and the usage section, and output information regarding the allocation to each operator; and the terminal including a second processor configured to output predetermined information to the server.

The present application claims priority to and incorporates by reference the entire contents of Japanese Patent Application No. 2020-143638 filed in Japan on Aug. 27, 2020.

### BACKGROUND

The present disclosure relates to an information providing system, an information providing device, and a computer readable recording medium.

A ticket across a plurality of transportation operators (railroad, subway, bus, ship, and the like) (hereinafter referred to as an excursion pass) is known (see, for example, JP 2020-071107 A).

### SUMMARY

Since the excursion pass is provided by a plurality of transportation operators (hereinafter referred to as the “operators”), it is necessary to distribute sales (revenue) after the sale. However, for example, when the number of users of a transportation unit provided by each operator is uneven, if the sales of the excursion pass are evenly distributed, the sense of unfairness will occur.

There is a need for an information providing system, an information providing device, and a computer readable recording medium that are able to fairly distribute the sales of the excursion passes to the operators that provide the excursion passes.

According to one aspect of the present disclosure, there is provided an information providing system including: a server including a first processor configured to provide an excursion pass that allows a user to use a plurality of transportation units to a terminal of the user, estimate a transportation unit used by the user among the plurality of transportation units, and a usage section of the transportation unit, calculate allocation of sales of the excursion pass to each operator providing the plurality of transportation units based on an estimation result of the transportation unit and the usage section, and output information regarding the allocation to each operator; and the terminal including a second processor configured to output predetermined information to the server.

### BRIEF DESCRIPTION OF THE DRAWINGS

FIG. 1 is a schematic diagram illustrating an overall configuration of an information providing system according to an embodiment;

FIG. 2 is a block diagram illustrating details of each component of the information providing system according to the embodiment;

FIG. 3 is a diagram illustrating an example of a route search condition input screen to be displayed on a terminal in the information providing system according to the embodiment;

FIG. 4 is a diagram illustrating an example of a route search result display screen to be displayed on a terminal in the information providing system according to the embodiment;

FIG. 5 is a diagram illustrating an example of an electronic ticket corresponding to an excursion pass displayed on a terminal in the information providing system according to the embodiment; and

FIG. 6 is a flowchart illustrating an example of an information providing method executed by the information providing system according to the embodiment.

### DETAILED DESCRIPTION

The information providing device according to an embodiment will be described with reference to the drawings. Note that the components in the embodiment described below include those that are easily replaced by those skilled in the art or those that are substantially the same.

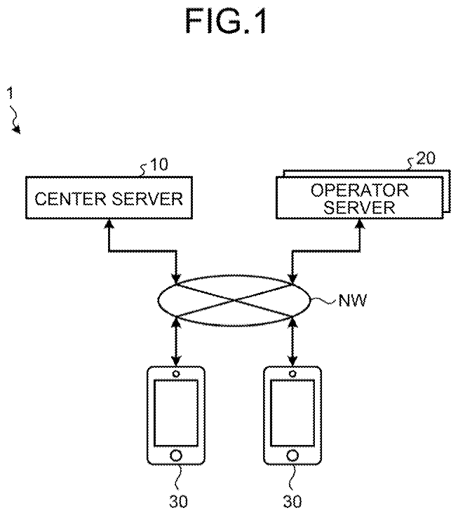

The information providing system including the information providing device according to the embodiment will be described with reference to FIGS. 1 to 5. As illustrated in FIG. 1, an information providing system 1 includes a center server 10, a plurality of operator servers 20, and a plurality of terminals 30. The information providing device according to the embodiment is realized by the function of the center server 10 of the information providing system 1. The center server 10, the operator servers 20, and the terminals 30 all have a communication function, and are configured to be able to communicate with each other through a network NW. This network NW includes, for example, the Internet, a mobile phone network, and the like.

The center server 10 is for providing predetermined information to the terminal 30 owned by the user and the operator server 20 that provides a transportation unit. Specifically, the center server 10 performs multimodal route search from the starting point to the destination by combining one or more of a plurality of transportation units such as automobiles, walking, bicycles, and public transportation facilities, and provides the route search result to the terminal 30. Further, the center server 10 provides the terminal 30 with an excursion pass that may use a plurality of transportation units. Moreover, the center server 10 provides the operator server 20 with information regarding the allocation of sales of the excursion pass used by the user. The center server 10 is realized by a workstation or a general-purpose computer such as a personal computer.

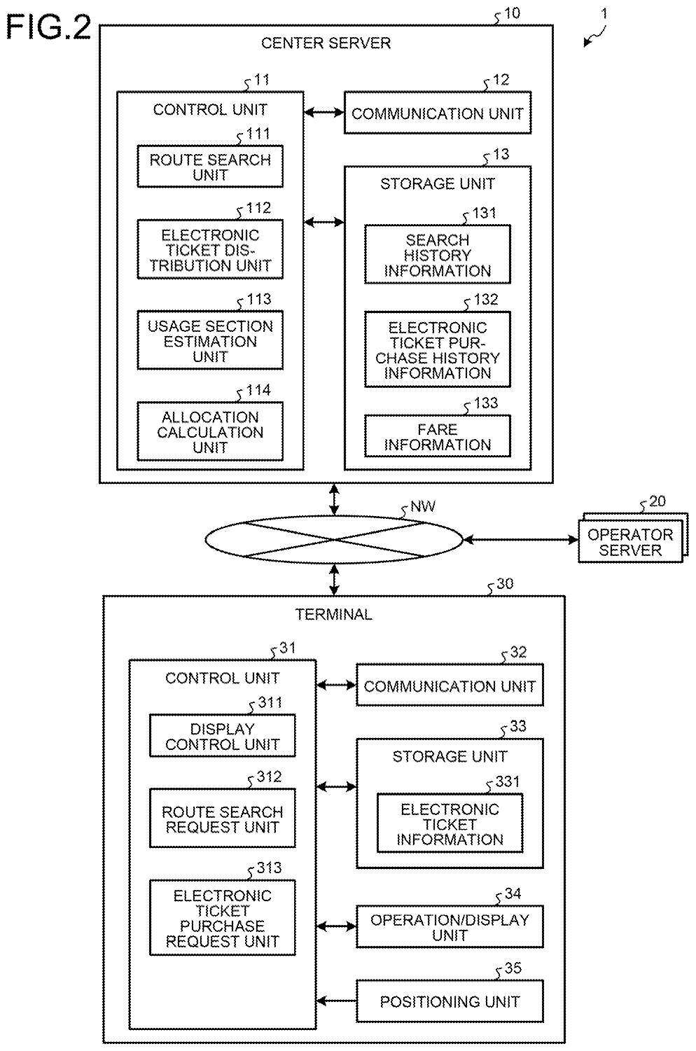

As illustrated in FIG. 2, the center server 10 includes a control unit (first processor) 11, a communication unit 12, and a storage unit 13. Specifically, the control unit 11 includes a processor including a central processing unit (CPU), a digital signal processor (DSP), and a field-programmable gate array (FPGA), and a memory (main storage unit) including a random access memory (RAM) and a read only memory (ROM).

The control unit 11 loads a program stored in the storage unit 13 into a work area of the main storage unit and executes it, and controls each constituent unit or the like through the execution of the program to realize a function that meets a predetermined purpose. The control unit 11 functions as a route search unit 111, an electronic ticket distribution unit 112, a usage section estimation unit 113, and an allocation calculation unit 114 through the execution of the program stored in the storage unit 13.

The route search unit 111 performs a multimodal route search by combining a plurality of transportation units by communicating with the plurality of operator servers 20 on the basis of a route search request acquired from the terminal 30. Then, the route search unit 111 transmits the result of the route search to the terminal 30 and stores it in the storage unit 13 as search history information 131.

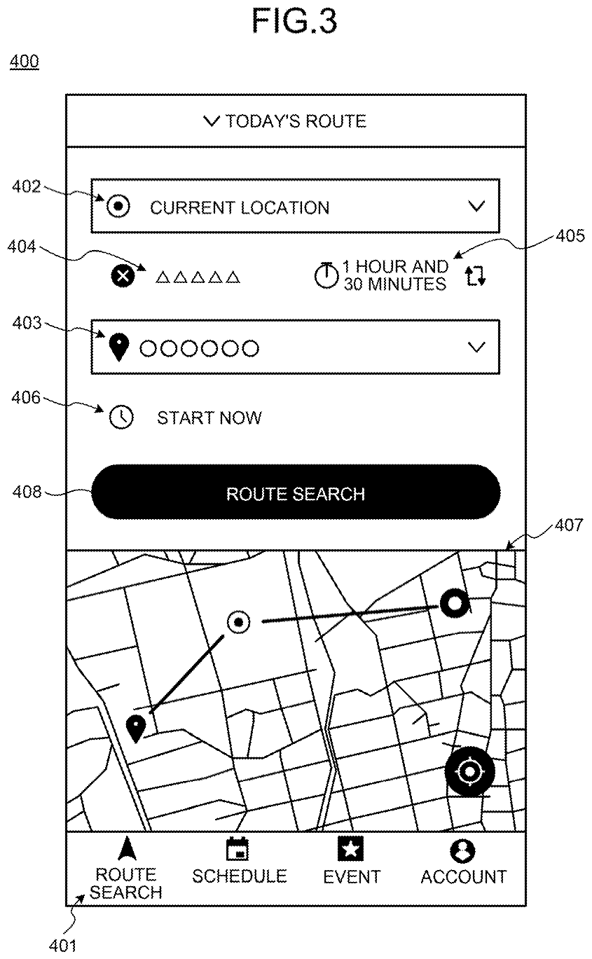

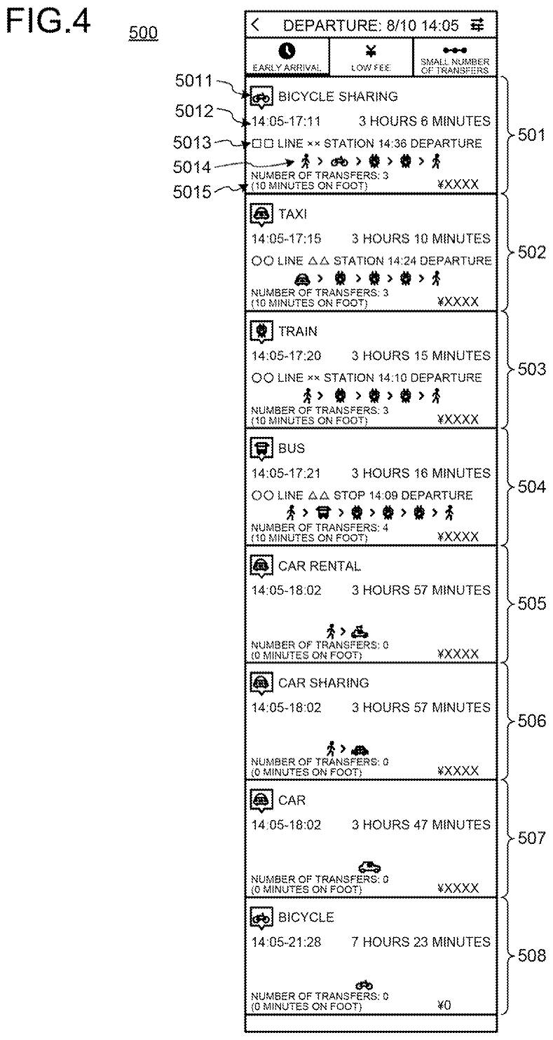

Here, FIG. 3 illustrates an example of a route search condition input screen 400 displayed on an operation/display unit 34 of the terminal 30 when the route search unit 111 performs route search. Further, FIG. 4 illustrates an example of a route search result display screen 500 displayed on the operation/display unit 34 of the terminal 30 when the route search unit 111 performs route search.

The input screen 400 of FIG. 3 is displayed on the operation/display unit 34 when, for example, in a route search application installed on the terminal 30, a route search button 401 of the menu at the bottom in the drawing is pressed (for example, a touch operation on the corresponding position of the operation/display unit 34). The input screen 400 includes a starting point box 402, a destination box 403, a waypoint box 404, a stay time setting menu 405, a departure time setting menu 406, a map display area 407, and a route search execution button 408.

The starting point box 402 is for setting the starting point in the multimodal route search. In the starting point box 402, for example, the current position of the terminal 30 detected by a positioning unit 35 of the terminal 30 is set as a default setting.

The destination box 403 is for setting the starting point in the multimodal route search. The waypoint box 404 is for setting a waypoint in the multimodal route search. The stay time setting menu 405 is for setting the stay time at a waypoint in the multimodal route search. The departure time setting menu 406 is for setting the departure time from the starting point in the multimodal route search.

In the map display area 407, a map image of the area including the starting point, the destination, and the waypoint set in the starting point box 402, the destination box 403, and the waypoint box 404 is displayed. The route search execution button 408 is for causing the route search unit 111 to execute the multimodal route search according to the contents set in the starting point box 402, the destination box 403, the waypoint box 404, the stay time setting menu 405, and the departure time setting menu 406. When the route search execution button 408 is pressed by the user, a route search request is transmitted from the terminal 30 to the center server 10. Then, the route search unit 111 performs route search on the basis of the route search request.

On the input screen 400 of FIG. 3, when the route search execution button 408 is pressed by the user and then the route search result is sent from the route search unit 111 to the terminal 30, the screen transitions to the display screen 500 illustrated in FIG. 4. Route candidate display areas 501 to 508 corresponding to a plurality of route candidates are displayed on the display screen 500.

The route candidate display areas 501 to 508 include, for example, a display field 5011 for displaying typical transportation units included in the route candidates, a display field 5012 for displaying the transportation time, a display field 5013 for displaying a boarding station and an alighting station of public transportation facilities, a display field 5014 for displaying the symbol mark of each transportation unit, a display field 5015 for displaying the number of times of transfer and the walking time, and the like.

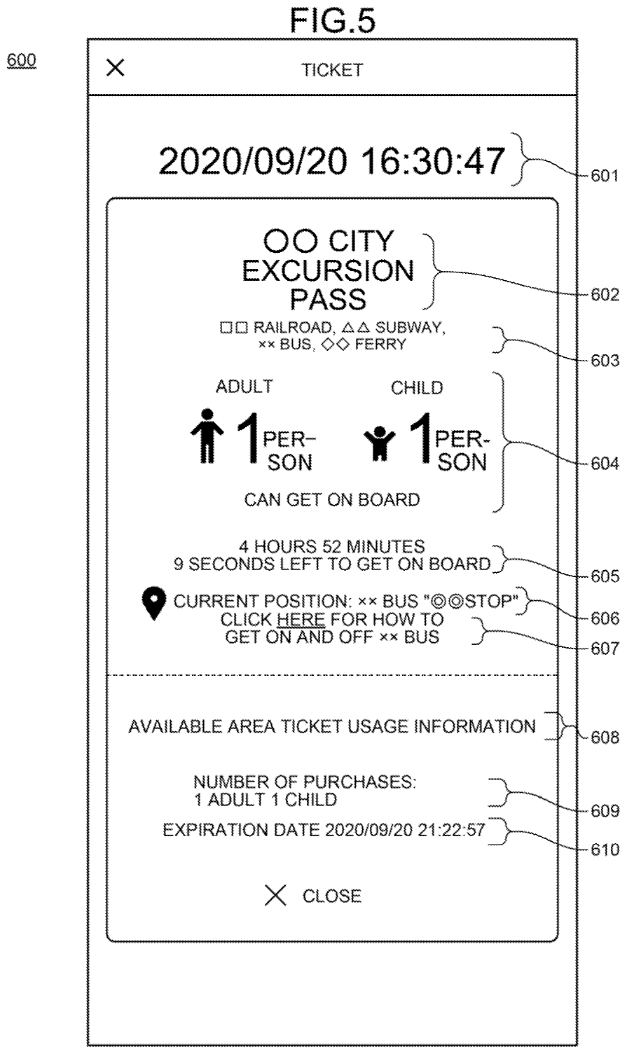

The electronic ticket distribution unit 112 distributes an electronic ticket to the terminal 30. This “electronic ticket” is an electronic version of a paper ticket issued by the operator. Further, the electronic ticket in the present embodiment assumes an excursion pass that allows free use of a plurality of transportation facilities (railroad, subway, bus, ship, and the like) within a predetermined period and within a predetermined area (see FIG. 5).

Specifically, when the electronic ticket distribution unit 112 acquires an electronic ticket purchase request from the terminal 30, the electronic ticket distribution unit 112 generates electronic ticket information on the basis of the purchase request. Then, the electronic ticket distribution unit 112 transmits the generated electronic ticket information to the terminal 30. Further, the electronic ticket distribution unit 112 stores the information regarding the sold electronic ticket in the storage unit 13 as electronic ticket purchase history information 132.

Note that payment of the electronic ticket may be performed, for example, in the information providing system 1 or may be performed through an external payment system (for example, a financial institution). When the payment of the electronic ticket is performed in the information providing system 1, the payment is performed at the same time when the electronic ticket is purchased through an electronic ticket application installed on the terminal 30. Then, when the electronic ticket purchase request is transmitted from the terminal 30 to the center server 10, electronic ticket payment completion information is also transmitted at the same time. Further, when the payment of the electronic ticket is performed through the external payment system, the electronic ticket payment completion information is transmitted from the external payment system to the center server 10 separately from the electronic ticket purchase request transmitted from the terminal 30.

The usage section estimation unit 113 estimates the transportation unit used by the user among the plurality of transportation units provided by the operators, and the usage section of the transportation unit. The usage section estimation unit 113 may estimate the transportation unit and the usage section on the basis of the user's position information acquired from the terminal 30. In this case, the user's position information is acquired by a GPS sensor (positioning unit 35) mounted on the terminal 30, or acquired when a communication unit 32 of the terminal 30 communicates with another device via short-range wireless communication (for example, wireless fidelity (Wi-Fi) (registered trademark) or Bluetooth (registered trademark) low energy (BLE)). By acquiring the user's position information from the terminal 30 in this way, it is possible to easily estimate which section of which transportation unit the user has used.

When, for example, the user's position information at the usage start point of a certain transportation unit and the user's position information at the usage end point of the transportation unit are acquired from the terminal 30, the usage section estimation unit 113 may estimate that the user has used the transportation unit in the section between the usage start point and the usage end point. That is, the usage section estimation unit 113 estimates the transportation unit operating between the usage start point and the usage end point as the transportation unit used by the user. Further, the usage section estimation unit 113 estimates the section between the usage start point and the usage end point as the usage section of the transportation unit. In this way, by using the user's position information detected at the two points: the usage start point (for example, the boarding station) and the usage end point (for example, the alighting station), it is possible to accurately estimate which section of which transportation unit the user has used.

Further, for example, when the user's position information at the usage start point of a first transportation unit and the user's position information at the usage start point of a second transportation unit connected after the first transportation unit are acquired from the terminal 30, the usage section estimation unit 113 may estimate the user's position at the usage end point of the first transportation unit from the user's position information at the usage start point of the second transportation unit. That is, when the user has used a plurality of transportation units (first transportation unit and second transportation unit) and only the position information at the time of boarding these transportation units may be acquired, the alighting position (e.g., alighting station) of the preceding, first transportation unit is estimated by using the information of the boarding position (e.g., boarding station) of the second transportation unit connected after the first transportation unit.

For example, it is assumed that “subway A” is the first transportation unit, and “subway B” connected after subway A is the second transportation unit. In this case, the usage section estimation unit 113 uses the position information when the user boards at station X of subway A and the position information when the user boards at station Y of subway B, and estimates, for example, that station Z of subway A to which the user may transfer from station Y of subway B is the user's alighting station of subway A. That is, the usage section estimation unit 113 estimates that the user has used subway A (first transportation unit) in the section between station X, which is the usage start point (boarding station) of the user, and station Z, which is the estimated usage end point (alighting station). In this way, by estimating the position of the usage end point (for example, the alighting station) of the first transportation unit from the position of the usage start point (for example, the boarding station) of the second transportation unit, it is possible to estimate which section of which transportation unit the user has used by using only the position information of the usage start point.

Further, for example, when the user's position information at the usage end point of the first transportation unit and the user's position information at the usage end point of the second transportation unit connected before the first transportation unit are acquired from the terminal 30, the usage section estimation unit 113 may estimate the user's position at the usage start point of the first transportation unit from the user's position information at the usage end point of the second transportation unit. That is, when the user has used a plurality of transportation units (first transportation unit and second transportation unit) and only the position information at the time of alighting from these transportation units may be acquired, the boarding position (e.g., boarding station) of the preceding, first transportation unit is estimated by using the information of the alighting position (e.g., alighting station) of the second transportation unit connected before the first transportation unit.

For example, it is assumed that “subway A” is the first transportation unit, and “subway B” connected before subway A is the second transportation unit. In this case, the usage section estimation unit 113 uses the position information when the user alights at station X of subway A and the position information when the user alights at station Y of subway B, and, for example, estimates that station Z of subway A to which the user may transfer from station Y of subway B is the user's boarding station of subway A. That is, the usage section estimation unit 113 estimates that the user has used subway A (first transportation unit) in the section between station Z, which is the estimated usage start point (boarding station), and station X, which is the usage end point (alighting station). In this way, by estimating the position of the usage start point (for example, the boarding station) of the first transportation unit from the position of the usage end point (for example, the alighting station) of the second transportation unit, it is possible to estimate which section of which transportation unit the user has used by using only the position information of the usage end point.

The allocation calculation unit 114 calculates the allocation of the sales of the excursion pass to each operator that provides the plurality of transportation units on the basis of the estimation result of the usage section estimation unit 113. Then, the allocation calculation unit 114 transmits the calculated allocation information to the operator server 20 managed by each operator.

The allocation calculation unit 114 may calculate the allocation of the sales of the excursion pass to each operator on the basis of, for example, the estimation result of the transportation unit and the usage section in the usage section estimation unit 113 and a fare predetermined for each usage section. In this case, the allocation calculation unit 114 calculates the allocation of the sales of each operator with respect to the total sales of the excursion pass in consideration of the usage record of each user regarding transportation units and sections for which the excursion pass may be used, and the fare (fare information 133) predetermined by each operator for each section of the transportation unit. Thus, it is possible to fairly determine the allocation of the sales of the excursion pass while reflecting the usage record of each user and the fare determined by each operator.

Further, the allocation calculation unit 114 may calculate the allocation of the sales of the excursion pass to each operator on the basis of the estimation result of the transportation unit and the usage section in the usage section estimation unit 113 and the distance of the usage section, i.e., the length of the section used by the user. In this case, the allocation calculation unit 114 calculates the allocation of the sales of each operator with respect to the total sales of the excursion pass in consideration of the usage record of each user regarding transportation units and sections for which the excursion pass may be used, and the usage distance converted from the usage section of each user included in the usage record. Thus, it is possible to fairly determine the allocation of the sales of the excursion pass while reflecting the usage record of each user and the usage distance (boarding distance) of each user.

Further, the allocation calculation unit 114 may calculate the allocation of the sales of the excursion pass to each operator on the basis of the estimation result of the transportation unit and the usage section in the usage section estimation unit 113 and the usage time of the transportation unit. In this case, the allocation calculation unit 114 calculates the allocation of the sales of each operator with respect to the total sales of the excursion pass in consideration of the usage record of each user regarding transportation units and sections for which the excursion pass may be used, and the usage time (e.g., boarding time) of the transportation unit. Thus, it is possible to fairly determine the allocation of the sales of the excursion pass while reflecting the usage record of each user and the usage time (boarding time) of each user.

Further, the allocation calculation unit 114 may calculate the allocation of the sales of the excursion pass to each operator on the basis of the estimation result of the transportation unit and the usage section in the usage section estimation unit 113, the distance of the usage section, and the usage time of the transportation unit. Thus, it is possible to fairly determine the allocation of the sales of the excursion pass while reflecting the usage record of each user, the usage distance (boarding distance) of each user, and the usage time (boarding time) of each user.

The communication unit 12 includes, for example, a local area network (LAN) interface board, a wireless communication circuit for wireless communication, and the like. The communication unit 12 is connected to the network NW such as the Internet, which is a public communication network. Then, the communication unit 12 communicates with the operator server 20 and the terminal 30 by connecting to the network NW.

The storage unit 13 includes a recording medium such as an erasable programmable ROM (EPROM), a hard disk drive (HDD), and a removable medium. Examples of the removable medium include disc recording media such as universal serial bus (USB) memory, compact disc (CD), digital versatile disc (DVD), and Blu-ray (registered trademark) disc (BD). The storage unit 13 may store an operating system (OS), various programs, various tables, various databases, and the like.

The storage unit 13 stores the search history information 131, the electronic ticket purchase history information 132, and the fare information 133.

The search history information 131 is information indicating the history of the route search performed by the route search unit 111. The search history information 131 includes, for example, a route search condition, a route search result, and the like for each user (terminal 30).

The electronic ticket purchase history information 132 includes, for example, information such as the user who purchased the electronic ticket, the purchase date and time of the electronic ticket by the user, the number of purchases, the purchase amount, the expiration date, and the ticket type (adult or child).

The fare information 133 is information regarding the fare of the transportation unit predetermined by each operator (for example, railroad, subway, bus, ship, and the like). Examples of the fare information 133 include the base fare, the additional fare for each usage distance, the additional fare for each usage time, and the fare for each usage section (for example, between stations, between stops, and the like).

The operator server 20 is a server managed by an operator that provides a transportation unit used for multimodal route search. This center server 10 is realized by a workstation or a general-purpose computer such as a personal computer.

The servers that constitute the operator server 20 include, for example, route bus-related servers, railroad-related servers, highway bus-related servers, aviation-related servers, ship-related servers, taxi-related servers, ride-sharing-related servers, car-sharing-related servers, rental car-related servers, and bicycle-sharing-related servers.

The route bus-related server is operated by a route bus operating company or the like, and provides information regarding the operation of the route bus (for example, timetable, operation status including delays, current position of each vehicle, and the like) to the center server 10. Further, the railroad-related server is operated by a railroad operating company or the like, and provides information regarding the operation of the railroad (for example, timetable, operation status including delays, availability of each train that may be reserved, and the like) to the center server 10. Further, the highway bus-related server is operated by a highway bus operating company or the like, and provides information regarding the operation of the highway bus (for example, timetable, operation status including delays, availability of each vehicle, and the like) to the center server 10. Further, the aviation-related server is operated by an airplane operating company or the like, and provides information regarding the operation of the airplane (for example, timetable, operation status including delays, availability of each flight, and the like) to the center server 10.

Further, the ship-related server is operated by a ship operating company or the like, and provides information regarding the operation of the ship (for example, timetable, operation status including delays, availability of each service that may be reserved, and the like) to the center server 10. Further, the taxi-related server is operated by a taxi service providing company or the like, and provides various information regarding the service of the taxi (for example, position information of each vehicle, operation status including vacant/occupied, and the like) to the center server 10. Further, the ride-sharing-related server is operated by a ride-sharing service providing company or the like, and provides various information regarding the service of ride sharing (for example, current position of each vehicle operated by ride sharing, whether a vehicle may be allocated, and the like) to the center server 10. Further, the car-sharing-related server is operated by a car-sharing service providing company or the like, and provides various information regarding the service of car sharing (for example, the number of parking spaces at each station that provides shared cars, the number of currently available cars, the number of returnable cars, and the like) to the center server 10.

Further, the rental car-related server is operated by a rental car service providing company or the like, and provides various information regarding the service of rental car (for example, the vehicle types that may be prepared at each business office that rents a car, the number of currently preparable cars of each car type at each business office, and the like) to the center server 10. Further, the bicycle-sharing-related server is operated by a bicycle-sharing service providing company or the like, and provides various information regarding the service of bicycle sharing (for example, the number of bicycles that may be provided at each of a plurality of bicycle ports that provides shared bicycles, the number of currently available bicycles, and the like) to the center server 10. In this way, the center server 10 performs the multimodal route search on the basis of the information provided from each server constituting the operator server 20.

The operator server 20 acquires information regarding the allocation of the sales of the excursion pass from the allocation calculation unit 114 of the center server 10. Then, each operator that manages the operator server 20 receives the distribution of the sales of the excursion pass according to the above-mentioned allocation.

The terminal 30 is for transmitting (outputting) predetermined information to the center server 10. The terminal 30 transmits, for example, a route search request, position information detected by the positioning unit 35 of the terminal 30, and the like to the center server 10. Further, the terminal 30 displays the electronic ticket information acquired from the center server 10, the result of the route search, and the like on the operation/display unit 34. The terminal 30 is realized by, for example, a smartphone, a mobile phone, a tablet terminal, a wearable computer, or the like owned by the user.

As illustrated in FIG. 2, the terminal 30 includes a control unit (second processor) 31, the communication unit 32, a storage unit 33, the operation/display unit (display) 34, and the positioning unit 35. The control unit 31 functions as a display control unit 311, a route search request unit 312, and an electronic ticket purchase request unit 313 through the execution of the program stored in the storage unit 33.

The display control unit 311 controls the display on the operation/display unit 34. The display control unit 311 causes the operation/display unit 34 to display, for example, the route search condition input screen 400 (see FIG. 3), the route search result display screen 500 (see FIG. 5), and an electronic ticket face screen 600 (see FIG. 5).

The electronic ticket face screen 600 illustrated in FIG. 5 includes an area 601 for displaying the current time, an area 602 for displaying the title of the electronic ticket, an area 603 for displaying the operator for which the electronic ticket may be used, an area 604 for displaying the ticket type (adult or child) of the electronic ticket, areas 605 and 610 for displaying the expiration date of the electronic ticket, an area 606 for displaying the user's current position, an area 607 for displaying a method of using a transportation unit to be used, an area 608 for displaying the area where the electronic ticket may be used and usage guidance, and an area 609 for displaying the number of purchases.

The route search request unit 312 transmits a route search request to the center server 10 in response to a user operation. Specifically, when the route search execution button 408 on the route search condition input screen 400 (see FIG. 3) is pressed by the user, the route search request unit 312 transmits a route search request based on the input content to the center server 10.

The electronic ticket purchase request unit 313 transmits the electronic ticket purchase request to the center server 10 in response to a user operation. Then, when the electronic ticket purchase request unit 313 acquires the electronic ticket information from the center server 10, the electronic ticket purchase request unit 313 stores the information as electronic ticket information 331 in the storage unit 33.

The communication unit 32 communicates with the center server 10 by wireless communication via the network NW. Further, the communication unit 32 may also perform short-range wireless communication such as Wi-Fi and BLE with another device. The storage unit 33 stores the electronic ticket information 331.

The electronic ticket information 331 is information regarding the electronic ticket purchased by the user and includes, for example, information such as the purchase date and time of the electronic ticket, the number of purchases, the purchase amount, the expiration date, and the ticket type (adult or child). Note that the storage unit 33 stores, for example, in addition to the electronic ticket information 331, application programs (route search application and electronic ticket application) for realizing the display control unit 311, the route search request unit 312, and the electronic ticket purchase request unit 313.

The operation/display unit 34 includes, for example, a touch panel display or the like, and has an input function for receiving an operation by a user's finger or a pen, and a display function for displaying various information on the basis of the control of the display control unit 311. The operation/display unit 34 displays the route search condition input screen 400 (see FIG. 3), the route search result display screen 500 (see FIG. 4), the electronic ticket information (see FIG. 5), an electronic ticket purchase screen, and the like on the basis of the control of the display control unit 311

The positioning unit 35 receives radio waves from a global positioning system (GPS) satellite and detects the information regarding the current position of the terminal 30 (hereinafter referred to as “position information”). The method for detecting the position information is not limited to the method using GPS satellites, and may use, for example, a method combining light detection and ranging or laser imaging detection and ranging (LiDAR) and a three-dimensional digital map, or the like.

The positioning unit 35 detects the position information when the user activates the electronic ticket application and the electronic ticket information (see FIG. 5) of the excursion pass is displayed on the operation/display unit 34, and transmits the detected position information to the control unit 31. Note that the situation in which the user activates the electronic ticket application includes, for example, a situation in which an electronic ticket is presented to a crew member when the user boards the transportation unit or when the user alights from the transportation unit. In this way, by acquiring the position information only when the user activates the electronic ticket application, it is possible to reduce the processing load of the terminal 30 as compared with the case where the position information is constantly acquired.

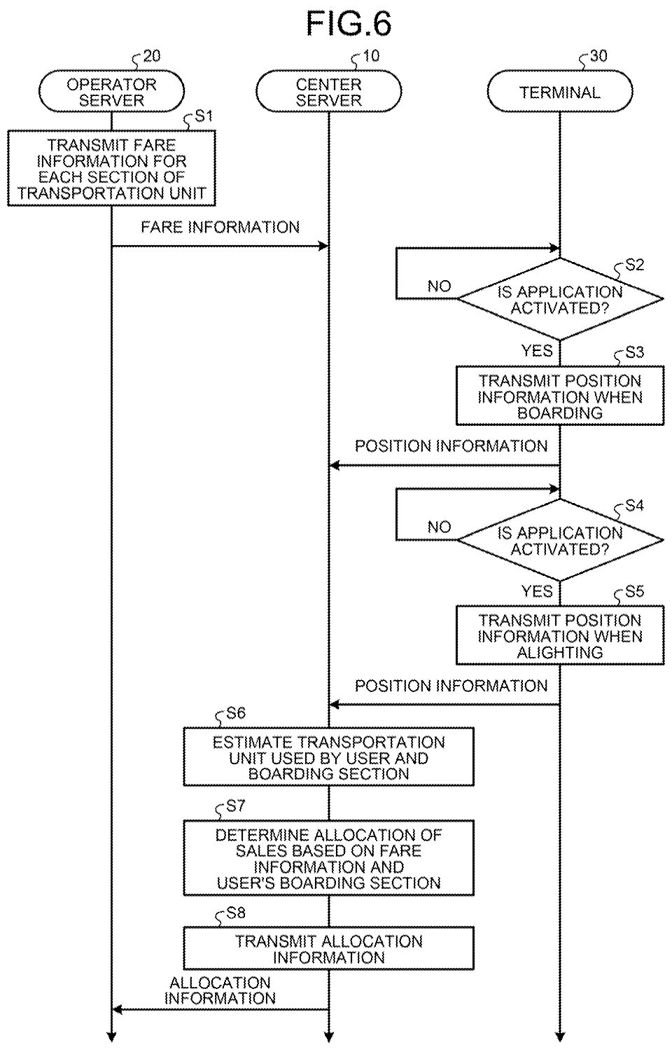

An example of the processing procedure of the information providing method executed by the information providing system 1 according to the embodiment will be described with reference to FIG. 6. In the drawing, an example of the case is described in which the position information when the user boards the transportation unit (usage start point) and the position information when the user alights from the transportation unit (usage end point) are acquired, and the allocation of the sales of the excursion pass is determined on the basis of these pieces of information and the fare information 133.

First, the operator server 20 transmits the fare information 133 for each section of each transportation unit to the center server 10 (Step S1). Subsequently, the display control unit 311 of the terminal 30 determines whether or not the electronic ticket application is activated (Step S2). In Step S2, it is determined whether or not the electronic ticket application is activated in order to present the electronic ticket to the crew member, for example, when the user boards the transportation unit.

When it is determined that the electronic ticket application has not been activated (No in Step S2), the display control unit 311 returns to Step S2. On the other hand, when it is determined that the electronic ticket application has been activated (Yes in Step S2), the display control unit 311 transmits the user's position information when boarding the transportation unit detected by the positioning unit 35 to the center server 10 (Step S3).

Subsequently, the display control unit 311 of the terminal 30 determines whether or not the electronic ticket application is activated (Step S4). In Step S4, it is determined whether or not the electronic ticket application is activated in order to present the electronic ticket to the crew member, for example, when the user alights from the transportation unit.

When it is determined that the electronic ticket application has not been activated (No in Step S4), the display control unit 311 returns to Step S4. On the other hand, when it is determined that the electronic ticket application has been activated (Yes in Step S4), the display control unit 311 transmits the user's position information when alighting from the transportation unit detected by the positioning unit 35 to the center server 10 (Step S5).

Subsequently, the usage section estimation unit 113 estimates the transportation unit used by the user and the boarding section on the basis of the user's position information when boarding the transportation unit and the user's position information when alighting from the transportation unit (Step S6). Subsequently, the allocation calculation unit 114 determines (calculates) the allocation of the sales of the excursion pass (allocation for each operator) on the basis of the fare information 133 and the boarding section of the user (Step S7), and transmits the information regarding the determined allocation to the operator server 20 (Step S8). Thus, the present processing is completed.

As described above, with the information providing system, the information providing device, and the information providing program according to the embodiment, by estimating the transportation unit used by the user and its usage section, it is possible to fairly determine the allocation of sales to each operator, and thus the sense of unfairness among the operators is eliminated.

For example, with the information providing system, the information providing device, and the information providing program according to the embodiment, the estimation of the transportation unit used by the user and the usage section and the calculation of the allocation of the sales of the excursion pass are performed on the center server 10 side, but these pieces of processing may be performed on the terminal 30 side. Thus, the processing load on the center server 10 side may be reduced.

According to the present disclosure, by estimating the transportation unit used by the user and its usage section, it is possible to fairly determine the allocation of sales to each operator, and thus the sense of unfairness among the operators is eliminated.

Although the disclosure has been described with respect to the specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information providing system comprising:
a server comprising a first processor configured to
provide an excursion pass that allows a user to use a plurality of transportation units to a terminal of the user,
estimate a transportation unit used by the user among the plurality of transportation units, and a usage section of the transportation unit,
calculate allocation of sales of the excursion pass to each operator providing the plurality of transportation units based on an estimation result of the transportation unit and the usage section, and
output information regarding the allocation to each operator; and
the terminal comprising a second processor configured to output predetermined information to the server.

2. The information providing system according to claim 1, wherein the first processor is configured to estimate the transportation unit and the usage section based on position information of the user acquired from the terminal.

3. The information providing system according to claim 2, wherein the position information of the user is acquired by a GPS sensor mounted on the terminal or short-range wireless communication between the terminal and an external device.

4. The information providing system according to claim 2, wherein
The terminal includes a display,
the second processor is configured to display information of the excursion pass acquired from the server on the display, and
the position information of the user is acquired from the terminal when the information of the excursion pass is displayed on the display.

5. The information providing system according to claim 2, wherein
when the position information of the user at a usage start point of the transportation unit and the position information of the user at a usage end point of the transportation unit are acquired from the terminal, the first processor is configured to estimate that the user has used the transportation unit in a section between the usage start point and the usage end point.

6. The information providing system according to claim 2, wherein when the position information of the user at a usage start point of a first transportation unit and the position information of the user at a usage start point of a second transportation unit connected after the first transportation unit are acquired from the terminal, the first processor is configured to:
estimate a position of the user at a usage end point of the first transportation unit from the position information of the user at the usage start point of the second transportation unit; and
estimate that the user has used the first transportation unit in a section between the usage start point and the estimated usage end point.

7. The information providing system according to claim 2, wherein when the position information of the user at a usage end point of a first transportation unit and the position information of the user at a usage end point of a second transportation unit connected before the first transportation unit are acquired from the terminal, the first processor is configured to:
estimate a position of the user at a usage start point of the first transportation unit from the position information of the user at the usage end point of the second transportation unit; and
estimate that the user has used the first transportation unit in a section between the estimated usage start point and the usage end point.

8. The information providing system according to claim 1, wherein the first processor is configured to calculate allocation of sales of the excursion pass to each operator providing the plurality of transportation units based on an estimation result of the transportation unit and the usage section and a fare predetermined for the usage section.

9. The information providing system according to claim 1, wherein the first processor is configured to calculate allocation of sales of the excursion pass to each operator providing the plurality of transportation units based on an estimation result of the transportation unit and the usage section and a distance of the usage section.

10. The information providing system according to claim 1, wherein the first processor is configured to calculate allocation of sales of the excursion pass to each operator providing the plurality of transportation units based on an estimation result of the transportation unit and the usage section and usage time of the transportation unit.

11. The information providing system according to claim 1, wherein the first processor is configured to calculate allocation of sales of the excursion pass to each operator providing the plurality of transportation units based on an estimation result of the transportation unit and the usage section, a distance of the usage section, and usage time of the transportation unit.

12. An information providing device comprising:
a processor configured to:
provide an excursion pass that allows a user to use a plurality of transportation units to a terminal of the user;
estimate a transportation unit used by the user among the plurality of transportation units, and a usage section of the transportation unit;
calculate allocation of sales of the excursion pass to each operator providing the plurality of transportation units based on an estimation result of the transportation unit and the usage section; and
output information regarding the allocation to each operator.

13. The information providing device according to claim 12, wherein the processor is configured to estimate the transportation unit and the usage section based on position information of the user acquired from the terminal.

14. The information providing device according to claim 13, wherein the position information of the user is acquired by a GPS sensor mounted on the terminal or short-range wireless communication between the terminal and an external device.

15. The information providing device according to claim 13, wherein the position information of the user is acquired from the terminal when information of the excursion pass is displayed on a display provided on the terminal.

16. The information providing device according to claim 13, wherein when the position information of the user at a usage start point of the transportation unit and the position information of the user at a usage end point of the transportation unit are acquired from the terminal, the processor is configured to estimate that the user has used the transportation unit in a section between the usage start point and the usage end point.

17. The information providing device according to claim 13, wherein when the position information of the user at a usage start point of a first transportation unit and the position information of the user at a usage start point of a second transportation unit connected after the first transportation unit are acquired from the terminal, the processor is configured to:
estimate a position of the user at a usage end point of the first transportation unit from the position information of the user at the usage start point of the second transportation unit; and
estimate that the user has used the first transportation unit in a section between the usage start point and the estimated usage end point.

18. The information providing device according to claim 13, wherein when the position information of the user at a usage end point of a first transportation unit and the position information of the user at a usage end point of a second transportation unit connected before the first transportation unit are acquired from the terminal, the processor is configured to:
estimate a position of the user at a usage start point of the first transportation unit from the position information of the user at the usage end point of the second transportation unit; and
estimate that the user has used the first transportation unit in a section between the estimated usage start point and the usage end point.

19. The information providing device according to claim 12, wherein the processor is configured to calculate allocation of sales of the excursion pass to each operator providing the plurality of transportation units based on an estimation result of the transportation unit and the usage section and a fare predetermined for the usage section.

20. The information providing device according to claim 12, wherein the processor is configured to calculate allocation of sales of the excursion pass to each operator providing the plurality of transportation units based on an estimation result of the transportation unit and the usage section and a distance of the usage section.

21. The information providing device according to claim 12, wherein the processor is configured to calculate allocation of sales of the excursion pass to each operator providing the plurality of transportation units based on an estimation result of the transportation unit and the usage section and usage time of the transportation unit.

22. The information providing device according to claim 12, wherein the processor is configured to calculate allocation of sales of the excursion pass to each operator providing the plurality of transportation units based on an estimation result of the transportation unit and the usage section, a distance of the usage section, and usage time of the transportation unit.

23. A non-transitory computer-readable recording medium on which an executable program is recorded, the program causing a processor of a computer to execute:
providing an excursion pass that allows a user to use a plurality of transportation units to a terminal of the user;
estimating a transportation unit used by the user among the plurality of transportation units, and a usage section of the transportation unit;
calculating allocation of sales of the excursion pass to each operator providing the plurality of transportation units based on an estimation result of the transportation unit and the usage section; and
outputting information regarding the allocation to each operator.

24. The non-transitory computer-readable recording medium according to claim 23, wherein the program causes the processor to execute estimating the transportation unit and the usage section based on position information of the user acquired from the terminal.

25. The non-transitory computer-readable recording medium according to claim 24, wherein position information of the user is acquired by a GPS sensor mounted on the terminal or short-range wireless communication between the terminal and another device.

26. The non-transitory computer-readable recording medium according to claim 24, wherein the position information of the user is acquired from the terminal when information of the excursion pass is displayed on a display provided on the terminal.

27. The non-transitory computer-readable recording medium according to claim 24, wherein the program causes the processor to execute, when the position information of the user at a usage start point of the transportation unit and the position information of the user at a usage end point of the transportation unit are acquired from the terminal, estimating that the user has used the transportation unit in a section between the usage start point and the usage end point.

28. The non-transitory computer-readable recording medium according to claim 24, wherein the program causes the processor to execute:
when the position information of the user at a usage start point of a first transportation unit and the position information of the user at a usage start point of a second transportation unit connected after the first transportation unit are acquired from the terminal, estimating a position of the user at a usage end point of the first transportation unit from the position information of the user at the usage start point of the second transportation unit; and
estimating that the user has used the first transportation unit in a section between the usage start point and the estimated usage end point.

29. The non-transitory computer-readable recording medium according to claim 24, wherein the program causes the processor to execute:
when the position information of the user at a usage end point of a first transportation unit and the position information of the user at a usage end point of a second transportation unit connected before the first transportation unit are acquired from the terminal, estimating a position of the user at a usage start point of the first transportation unit from the position information of the user at the usage end point of the second transportation unit; and
estimating that the user has used the first transportation unit in a section between the estimated usage start point and the usage end point.

30. The non-transitory computer-readable recording medium according to claim 23, wherein the program causes the processor to execute calculating allocation of sales of the excursion pass to each operator providing the plurality of transportation units based on an estimation result of the transportation unit and the usage section and a fare predetermined for the usage section.

31. The non-transitory computer-readable recording medium according to claim 23, wherein the program causes the processor to execute calculating allocation of sales of the excursion pass to each operator providing the plurality of transportation units based on an estimation result of the transportation unit and the usage section and a distance of the usage section.

32. The non-transitory computer-readable recording medium according to claim 23, wherein the program causes the processor to execute calculating allocation of sales of the excursion pass to each operator providing the plurality of transportation units based on an estimation result of the transportation unit and the usage section and usage time of the transportation unit.

33. The non-transitory computer-readable recording medium according to claim 23, wherein the program causes the processor to execute calculating allocation of sales of the excursion pass to each operator providing the plurality of transportation units based on an estimation result of the transportation unit and the usage section, a distance of the usage section, and usage time of the transportation unit.
